(19) United States
(12) Patent Application Publication
(10) Pub. No.: US 2025/0245019 A1
(43) Pub. Date: Jul. 31, 2025

(54) Processor Environment Agnostic Storage Protocol Based Information Handling System Firmware Management Operation

(71) Applicant: Dell Products L.P., Round Rock, TX (US)

(72) Inventors: Aniket Surekar, Nanded (IN); Shekar Babu Suryanarayana, Bangalore (IN); Anjali S, Kollemcode (IN)

(21) Appl. No.: 18/429,034

(22) Filed: Jan. 31, 2024

(51) Int. Cl. G06F 9/4401

(52) U.S. Cl. CPC G06F 9/4411; G06F 9/4416

(57) ABSTRACT

A firmware management operation. The firmware management operation includes providing an information handling system with a distributed BIOS, the distributed BIOS including a BIOS component and a BIOS variable; identifying a processor environment installed on an information handling system from a plurality of processor environments; performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed BIOS, the distributed BIOS including a BIOS component and a BIOS variable; identifying a processor environment installed on an information handling system from a plurality of processor environments; performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS, the distributed BIOS including a BIOS component and a BIOS variable; identifying a processor environment installed on an information handling system from a plurality of processor environments; performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

In another embodiment the invention relates to a computer-readable storage medium embodying computer program code, the computer program code comprising computer executable instructions configured for: providing an information handling system with a distributed BIOS, the distributed BIOS including a BIOS component and a BIOS variable; identifying a processor environment installed on an information handling system from a plurality of processor environments; performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 shows a simplified block diagram of a processor environment agnostic storage protocol based information handling system firmware management operation environment;

FIGS. 6a and 6c are a simplified block diagram showing the performance of a processor environment agnostic storage protocol based information handling system firmware management operation when a single boot block is corrupted;

FIGS. 7a through 7c are a simplified block diagram showing the performance of a processor environment agnostic storage protocol based information handling system firmware management operation when a plurality of boot blocks are corrupted;

FIG. 8 is a simplified block diagram showing a sequence of the performance of a processor environment agnostic storage protocol based information handling system firmware management operation.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the present disclosure include an appreciation that information handling systems can be configured with a plurality of different types of storage configurations. Various aspects of the present disclosure include an appreciation that an advanced host controller interface (AHCI) type storage interface and a redundant array of independent disks (RAID) storage configurations. Various aspects of the present disclosure include an appreciation that a transition between a boot mode for an AHCI type storage configuration and a boot mode for a RAID type storage configuration can carries a risk of metadata corruption. Various aspects of the present disclosure include an appreciation that this risk can be due to compatibility issues with specific drivers. Various aspects of the present disclosure include an appreciation that it can be difficult to recover from issues which arise from such a boot mode incompatibility. Various aspects of the present disclosure include an appreciation that it would be desirable to provide seamless switch protocol to facilitate uninterrupted booting of different types of storage configurations without risking system corruption.

Various aspects of the present disclosure include an appreciation that a challenge associated with uninterrupted booting of different types of storage configurations is related to the compatibility device drivers for AHCI type storage configurations and RAID type storage configurations.

Various aspects of the present disclosure include an appreciation that an incompatibility device driver accessed by another type of storage device can result metadata corruption leading to system instability. Various aspects of the present disclosure include an appreciation that certain storage device drivers are intended for specific processor environment or storage models. Various aspects of the present disclosure include an appreciation that certain processor environments include fabric module which are tightly coupled for AHCI storage configurations and RAID storage configurations. Various aspects of the present disclosure include an appreciation that certain processor environments do not allow override of their specific device drivers.

A system and method are disclosed for performing a processor environment agnostic storage protocol based information handling system firmware management operation. In certain embodiments, a processor environment agnostic storage protocol based information handling system firmware management system performs the processor environment agnostic storage protocol based information handling system firmware management operation.

In certain embodiments, the processor environment agnostic storage protocol based information handling system firmware management system includes a processor environment agnostic seamless transient storage protocol. In certain embodiments, the processor environment agnostic seamless transient storage protocol enables a failover storage protocol-based boot process. In certain embodiments, the processor environment agnostic storage protocol based information handling system firmware management system includes a processor environment agnostic bootloader. In certain embodiments, the processor environment agnostic bootloader performs a unified metadata based heterogenous operating system boot loading operation. In certain embodiments, the unified metadata based heterogenous operating system boot loading operation enables unified booting across a plurality of operating systems, a plurality of storage types, a plurality of storage vendors, or a combination thereof.

In certain embodiments, the processor environment agnostic storage protocol based information handling system firmware management operation implements remote storage based security encapsulation. In certain embodiments, the remote storage based security encapsulation includes cloud based security encapsulation. In certain embodiments, the remote storage based security encapsulation enables secure recovery of a failed failure boot block. In certain embodiments, the failed boot block includes a failed storage boot block.

In certain embodiments, the processor environment agnostic storage protocol based information handling system firmware management system provides a seamless and transient storage failover mechanism that can switch between AHCI and RAID storage configurations without any concerns about data corruption or metadata decoding. In certain embodiments, the unified metadata is compatible across heterogeneous operating systems. In certain embodiments, the unified metadata contributes to the processor environment agnosticism. In certain embodiments, the remote storage based security encapsulation for boot block recovery ensures system reliability.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

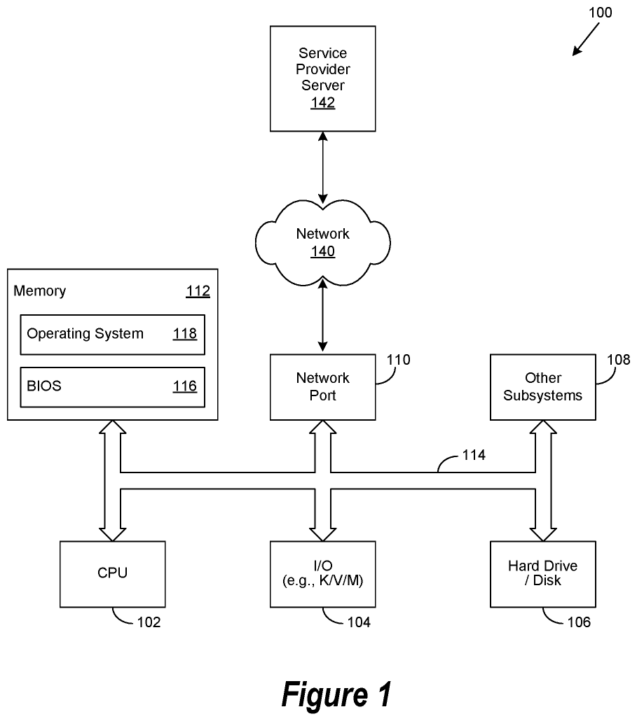

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), crasable programmable read-only memory (EPROM), electrically crasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a bootloader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In certain embodiments, the firmware management operation may be performed during operation of an IHS 100. In various embodiments, performance of the firmware management operation may result in the realization of improved operation of an IHS 100.

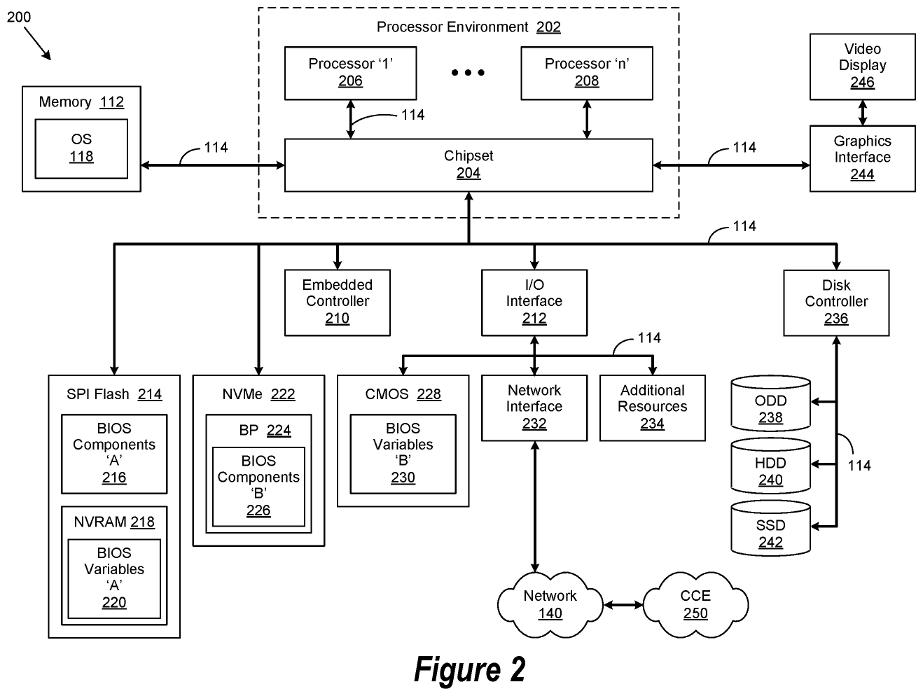

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a bootloader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

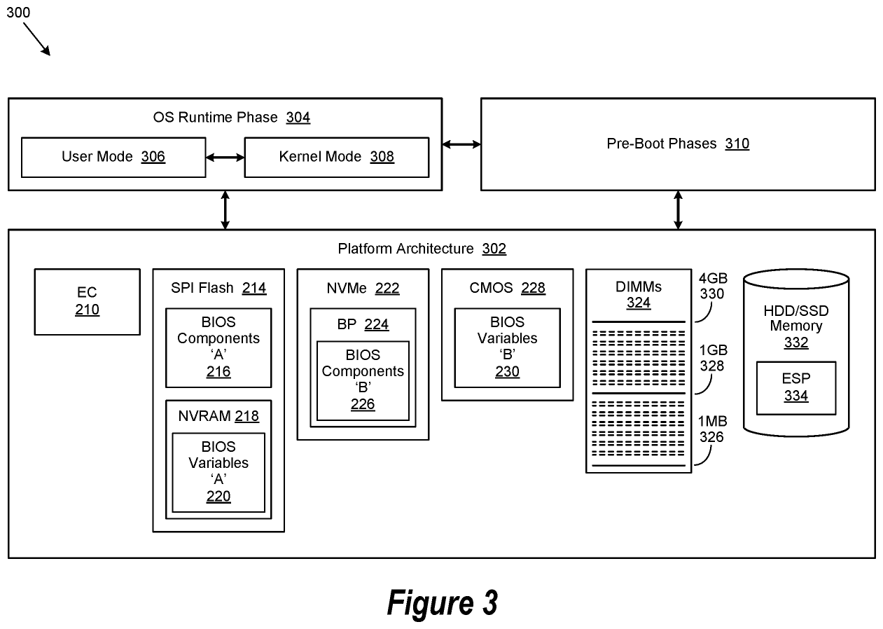

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, Nvidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it to control various data paths and support functions associated with a particular processor. Examples of such processors include those manufactured by Intel®, AMD®, Qualcom®, Broadcom®, Nvidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the bootloaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

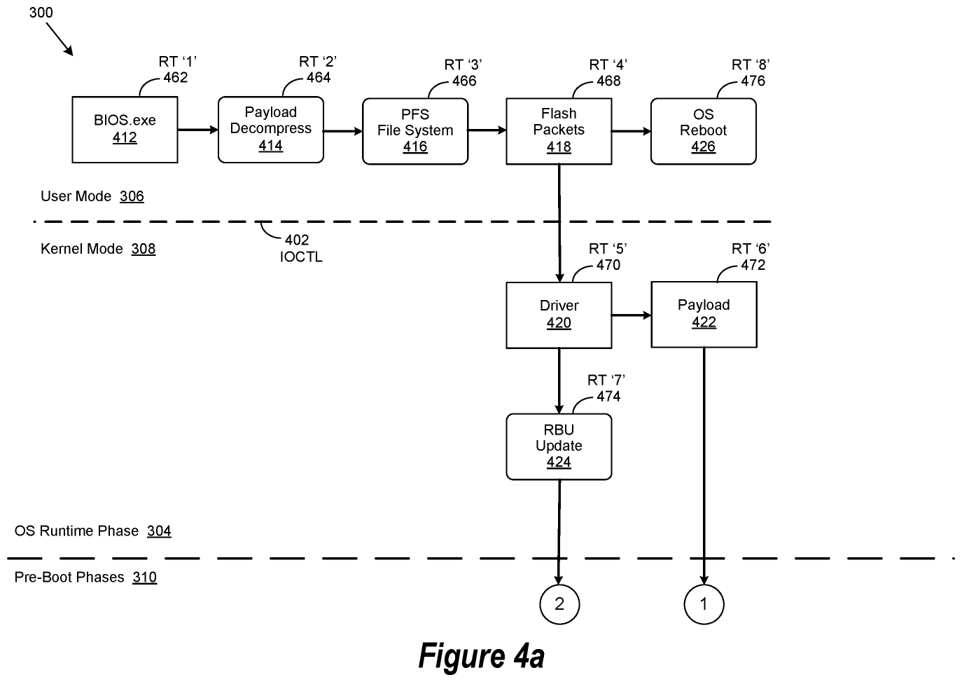

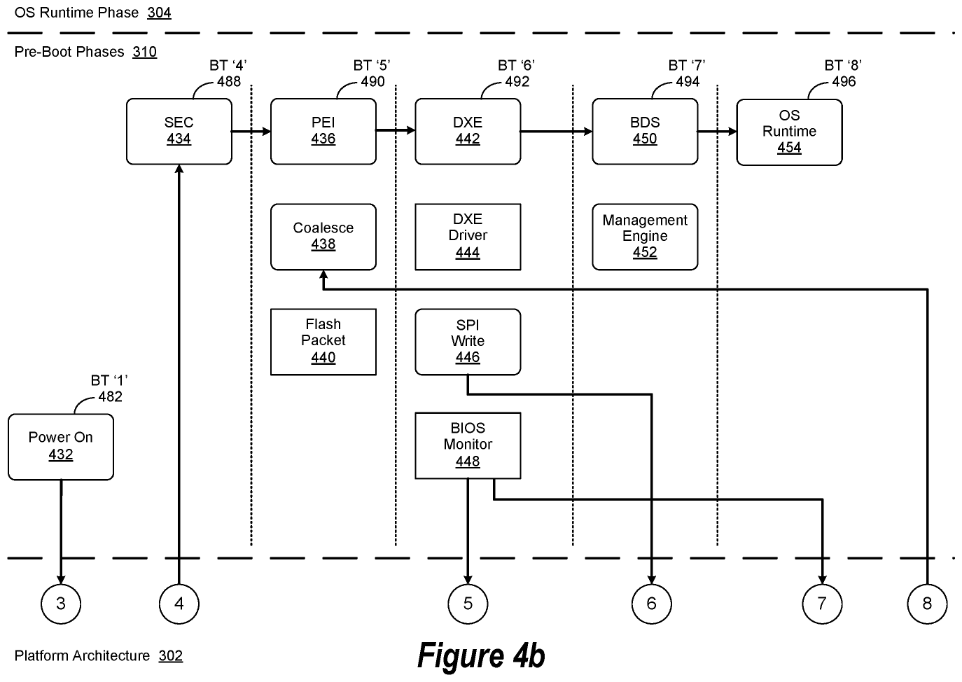

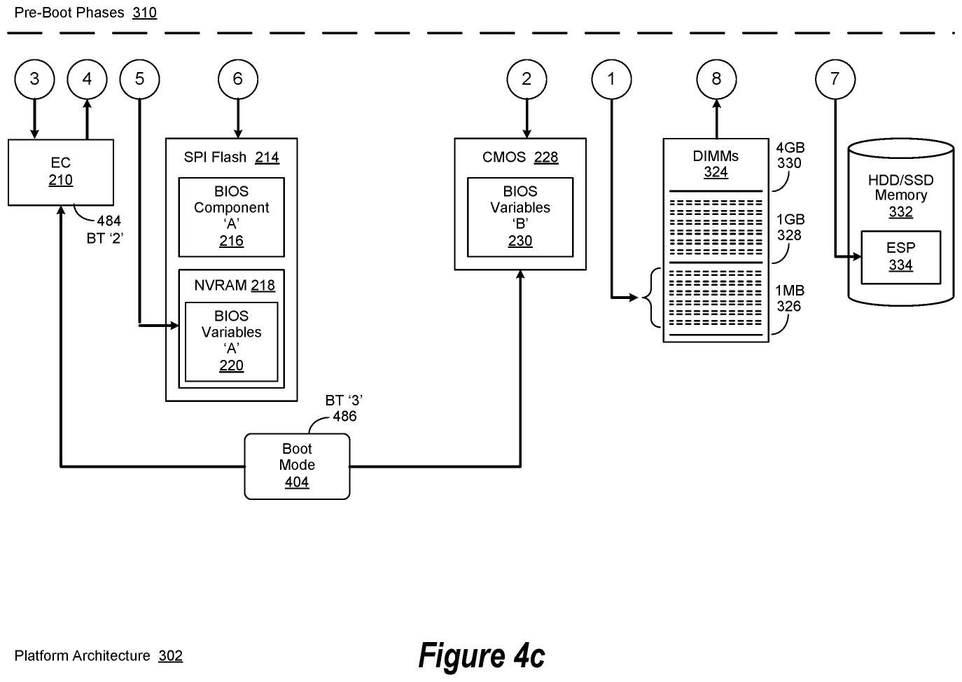

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or bootloaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver execution Environment (DXE) 442 phase operation in BT step 6′ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

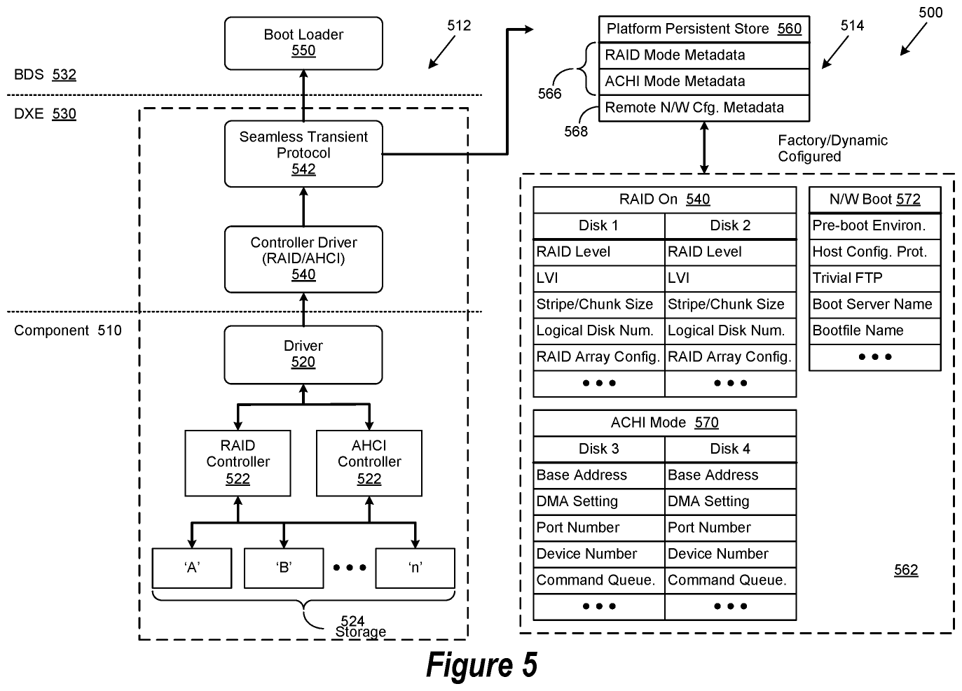

Referring to FIG. 5, a simplified block diagram of a processor environment agnostic storage protocol based information handling system firmware management operation environment 500 is shown. In certain embodiments, a firmware management operation may be implemented to perform a processor environment agnostic storage protocol based information handling system firmware management operation. In certain embodiments, the processor environment agnostic storage protocol based information handling system firmware management operation is performed within the processor environment agnostic storage protocol based information handling system firmware management environment 500. As used herein, a processor environment agnostic storage protocol based information handling system firmware management operation broadly refers to a firmware management operation, described in greater detail herein, performed directly, or indirectly, within a multi-processor operating environment 200 to seamlessly manage a plurality of storage configuration types. In certain embodiments, the managing the plurality of storage configuration types includes identifying, recovering, or a combination thereof, an issue relating to a storage configuration. In certain embodiments, the managing the plurality of storage configuration types is performed during a pre-boot phase of operation.

In certain embodiments, the seamless switching includes identifying and using storage configuration type specific device drivers. In certain embodiments, the seamless switching includes identifying and using processor environment architecture specific device drivers.

In certain embodiments, the processor environment agnostic storage protocol based information handling system firmware management operation environment 500 includes a component portion 510, a firmware portion 512, a storage portion 514, or a combination thereof. In certain embodiments, the component portion 510 corresponds to a storage component portion.

In certain embodiments, the storage component portion 510 includes a storage device driver module 520, one or more storage controllers 522 and one or more storage devices 524. In certain embodiments, the storage device driver module 520 includes a RAID type storage device driver, an AHCI type storage device driver, or a combination thereof. In certain embodiments, the storage device driver module 520 includes a block input/output type device driver. In certain embodiments, the storage device driver module 520 includes operating system agnostic storage device drivers. In certain embodiments, the one or more storage controllers 522 include a RAID type storage controller, an AHCI type storage controller, or a combination thereof. In certain embodiments, the one or more storage devices 524 include a RAID type storage device, an AHCI type storage device, or a combination thereof.

In certain embodiments, the firmware portion 512 includes a DXE phase portion 530, a BDS phase portion 532 or a combination thereof. In certain embodiments, the DXE phase portion 530 includes a driver module 540, a seamless transient protocol module 542, or a combination thereof. In certain embodiments, the BDS phase portion includes a bootloader module 550.

In certain embodiments, the storage portion 514 includes a platform specific storage portion 560, a metadata storage portion 562, or a combination thereof. In certain embodiments, the storage portion 514 comprises a remote storage portion. In certain embodiments, the platform specific storage portion 560 stores platform specific metadata 566, platform specific network configuration metadata 568, or a combination thereof. In certain embodiments, the metadata storage portion 562 includes one or more repositories of storage configuration type specific metadata 570, a repository of network boot metadata 572, or a combination thereof. In certain embodiments, the one or more repositories of storage configuration type specific metadata 570 include a repository of RAID storage configuration type metadata 540. In certain embodiments, the one or more repositories of storage configuration type specific metadata 570 include a repository of AHCI storage configuration type metadata.

In certain embodiments, the platform specific storage portion 560 stores unified metadata that is specific to a particular information handling system platform. In certain embodiments, the platform specific metadata 566 is obtained from the one or more repositories of storage configuration type specific metadata 570 based upon the specific information handling system configuration. In certain embodiments, the specific information handling system configuration includes a particular processor environment configuration, a particular storage type configuration, a particular network interface controller configuration, or a combination thereof. In certain embodiments, the platform specific metadata 566 is stored in the remote storage location when the specific information handling system is configured, fabricated, shipped, or a combination thereof.

In certain embodiments, the processor environment agnostic storage protocol based information handling system firmware management system includes a processor environment agnostic seamless transient storage protocol. As used herein, a processor agnostic seamless transient storage protocol broadly refers to a protocol for communicating with any of a plurality of different storage configurations where the communication is smooth and continuous as well as passing quickly (i.e., in near real time) from one storage configuration to another storage configuration. In certain embodiments, the processor environment agnostic seamless transient storage protocol is stored within the seamless transient storage protocol module 542. In certain embodiments, the processor environment agnostic seamless transient storage protocol enables a failover storage protocol-based boot process. In certain embodiments, the bootloader module 550 of the processor environment agnostic storage protocol based information handling system firmware management system includes a processor environment agnostic bootloader. In certain embodiments, the processor environment agnostic bootloader performs a unified metadata based heterogenous operating system boot loading operation. In certain embodiments, the unified metadata based heterogenous operating system boot loading operation enables unified booting across a plurality of operating systems, a plurality of storage types, a plurality of storage vendors, or a combination thereof.

In certain embodiments, the processor environment agnostic storage protocol based information handling system firmware management operation implements remote storage based security encapsulation. In certain embodiments, the remote storage based security encapsulation includes cloud based security encapsulation. In certain embodiments, the remote storage based security encapsulation enables secure recovery of a failed failure boot block. In certain embodiments, the failed boot block includes a failed storage boot block. In certain embodiments, the remote storage based security encapsulation is provided between the seamless transient protocol module 542 and the storage portion 514.

In certain embodiments, the processor environment agnostic storage protocol based information handling system firmware management system provides a seamless and transient storage failover mechanism that can switch between AHCI and RAID type storage configurations without any concerns about data corruption or metadata decoding. In certain embodiments, the unified metadata is compatible across heterogeneous operating systems. In certain embodiments, the unified metadata contributes to the processor environment agnosticism. In certain embodiments, the remote storage based security encapsulation for boot block recovery ensures system reliability.

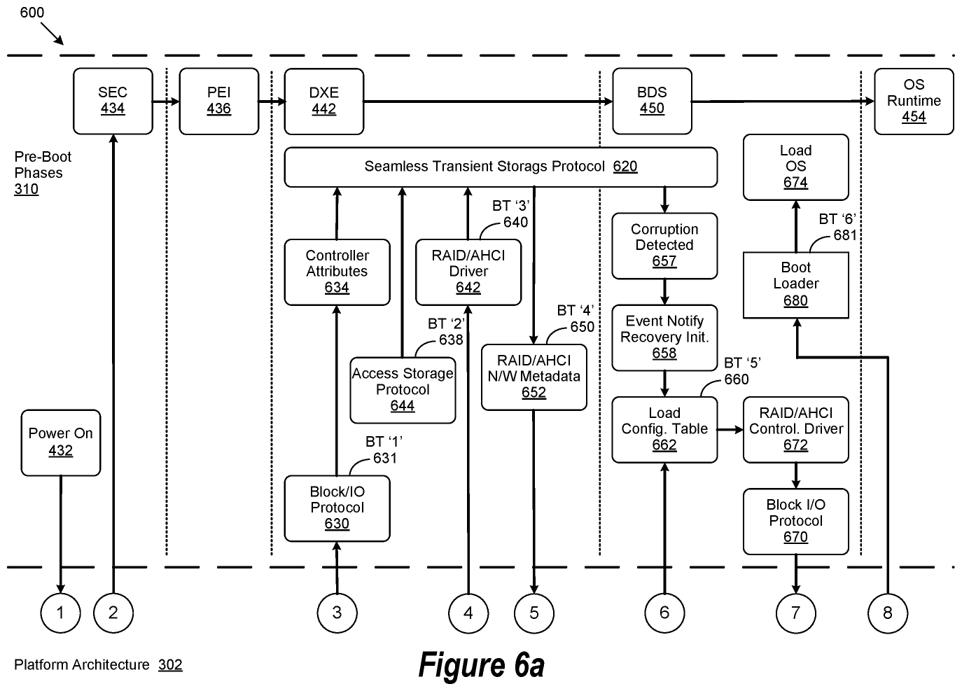

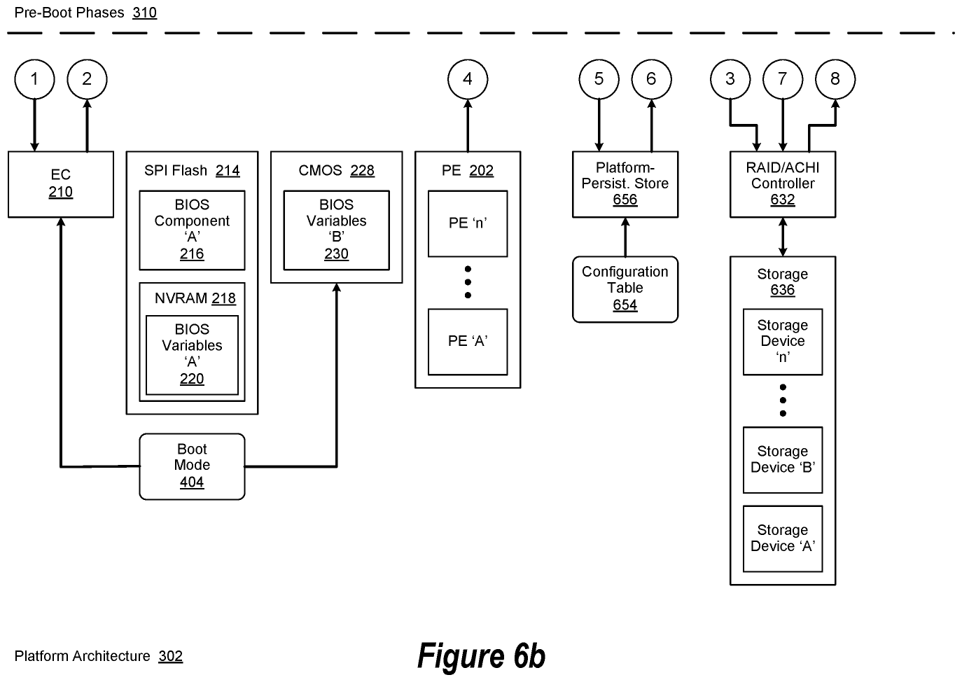

Referring to FIGS. 6a through 6c, a simplified block diagram of the performance of a processor environment agnostic storage protocol based information handling system firmware management operation 600 is shown. More specifically, the performance of a processor environment agnostic storage protocol based information handling system firmware management operation 600 when a storage mode switch or single boot block is corrupted is shown. In certain embodiments, the processor environment agnostic storage protocol based information handling system firmware management environment 600 includes a version of an architecture-specific distributed firmware management platform (ASDFMP) implemented in accordance with an embodiment of the invention to perform certain processor environment agnostic storage protocol based information handling system firmware management operations.

With the processor environment agnostic storage protocol based information handling system firmware management operation 600, it is possible to switch storage modes during a pre-boot phase 310 of operation. In certain embodiments, processor environment agnostic storage protocol based information handling system firmware management operation 600 can switch storage modes of operation without boot block corruption. In certain embodiments, boot block corruption is prevented even is a sudden power outage or an unforeseen malfunction in NVRAM occurs.

More specifically, the processor environment agnostic storage protocol based information handling system firmware management operation 600 makes use of a processor environment agnostic seamless transient storage protocol (STSP) 620. In certain embodiments, the seamless transient storage protocol provides a failover storage protocol-based boot operation which ensures a smooth transition when switching storage modes of operation.

More specifically, during an initial DXE boot phase 442, the seamless transient storage protocol 620 initiates communication with a storage device protocol 630, such as a Block IO Protocol, in pre-boot time (BT) step ‘1’ 631. In certain embodiments, the communication with the storage device protocol 630 is via a storage type specific driver. In certain embodiments, the storage specific driver is a RAID type driver, an AHCI type driver, or a combination thereof. In certain embodiments, the communication between the seamless transient storage protocol 620 and the storage device protocol 630 obtains storage type specific attributes such as storage type specific controller attributes. In certain embodiments, the storage device protocol 630 communicates with a storage device specific controller 632 to obtain the storage type specific controller attributes 634 associated with one or more storage devices 636. In certain embodiments, the storage type specific attributes include storage type specific metadata. In certain embodiments, the storage type specific attributes also include storage type specific network configuration metadata.

In certain embodiments, the processor environment agnostic storage protocol based information handling system firmware management operation 600 provides a unified metadata-based heterogeneous operating system bootloader which functions across a plurality operating systems and storage types.

In certain embodiments, the processor environment agnostic storage protocol based information handling system firmware management operation 600 uses in BT step ‘2’ 638 the seamless transient storage protocol 620 to collect information about initialized storage protocols 644 for a plurality of processor environment vendors, a plurality of storage devices, storage devices such as NVME, or a combination thereof. In certain embodiments, the processor environment agnostic storage protocol based information handling system firmware management operation 600 uses the seamless transient storage protocol 620 in BT step ‘3’ 640 to collect information about native processor environment storage device drivers 642 from a plurality of processor environment vendors, a plurality of storage device vendors, or a combination thereof.

In certain embodiments, the processor environment agnostic storage protocol based information handling system firmware management operation 600 uses in BT step ‘4’ 650 the seamless transient storage protocol 620 collected and acquired metadata 652 to configure a factory/dynamic table 654. In certain embodiments, the factory/dynamic table 654 is configured using information stored within a platform persistent storage 656. In certain embodiments, the seamless transient storage protocol 620 stores the collected and acquired metadata 652 in the platform persistent storage 656.

During a BDS phase 450, if the seamless transient storage protocol 620 detects occurrence of storage mode switching or occurrence of a runtime single boot block corruption 657, the seamless transient storage protocol 620 generates an event 658 to notify a user that a recovery operation has been initiated. In certain embodiments, the processor environment agnostic storage protocol based information handling system firmware management operation 600 uses the seamless transient protocol 620 to conduct a real-time evaluation of the occurrence of storage mode switching or occurrence of a runtime single boot block corruption 657 to determine whether to initiate an operating system loading operation. In certain embodiments, the processor environment agnostic storage protocol based information handling system firmware management operation 600 uses in BT step ‘5’ 660 the seamless transient storage protocol 620 to load a factory/dynamic configured table 662 from the persistent data storage 656. In certain embodiments, the loading is from the DXE phase 442 to the BDS phase 450.

In certain embodiments, the processor environment agnostic storage protocol based information handling system firmware management operation 600 uses the seamless transient protocol 620 accesses the configuration metadata from a factory or dynamically configured table 654. In certain embodiments, the processor environment agnostic storage protocol based information handling system firmware management operation 600 uses the seamless transient protocol 620 then proceeds to use a block I/O protocol 670 to load the compatible storage device driver specific to the particular processor environment and storage device type. In certain embodiments, the processor environment agnostic storage protocol based information handling system firmware management operation 600 in BT step ‘6’ 681 then loads the bootloader 680 with the corresponding driver 672 which in turn loads the operating system 674 without causing any disruptions to the system.

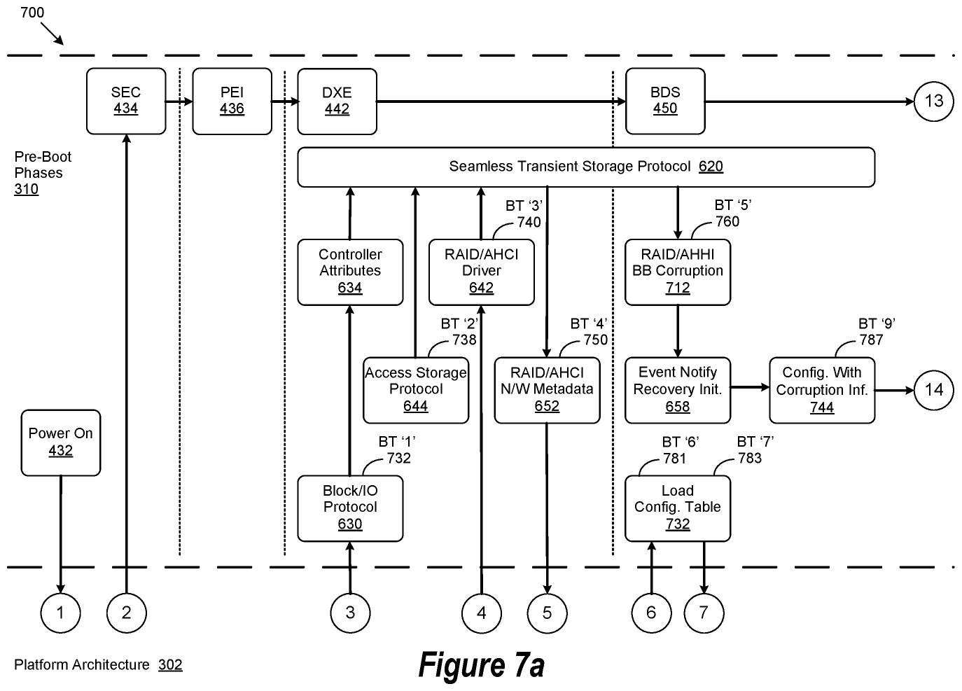

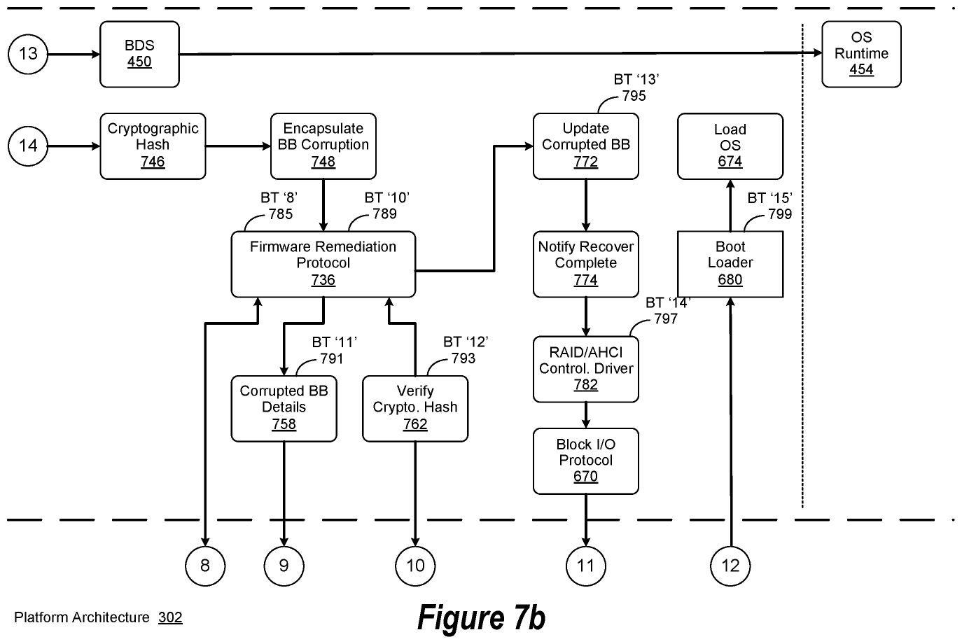

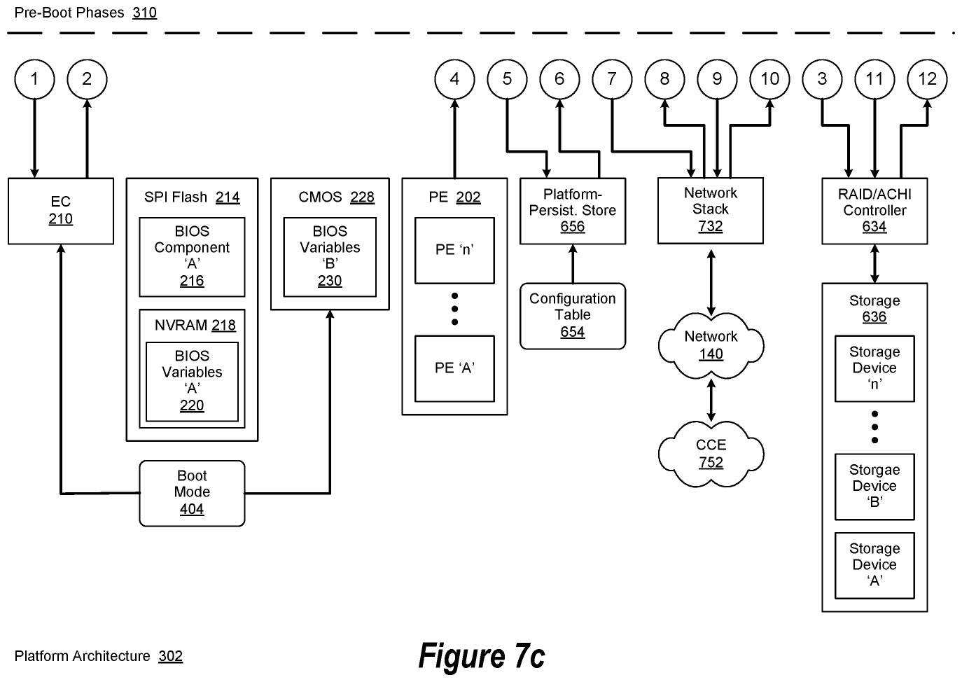

Referring to FIGS. 7a through 7c a simplified block diagram of the performance of a processor environment agnostic storage protocol based information handling system firmware management operation 700. More specifically, the performance of a processor environment agnostic storage protocol based information handling system firmware management operation 700 when a plurality of boot block corruptions are detected is shown. More specifically, the performance of a processor environment agnostic storage protocol based information handling system firmware management operation 700 when boot block corruption is detected in a plurality of storage device modes of operation is shown. In certain embodiments, the plurality of storage device modes of operation includes both an AHCI type storage device mode of operation and a RAID type storage device mode of operation.

More specifically, the processor environment agnostic storage protocol based information handling system firmware management operation 700 makes use of a processor environment agnostic seamless transient storage protocol (STSP) 620. In certain embodiments, the seamless transient storage protocol provides a failover storage protocol-based boot operation which ensures a smooth transition when switching storage modes of operation.

More specifically, during an initial DXE boot phase 442, the seamless transient storage protocol 620 initiates communication with a storage device protocol 630, such as a Block IO Protocol, in pre-boot time (BT) step ‘1’ 632. In certain embodiments, the communication with the storage device protocol 630 is via a storage type specific driver. In certain embodiments, the storage specific driver is a RAID type driver, an AHCI type driver, or a combination thereof. In certain embodiments, the communication between the seamless transient storage protocol 620 and the storage device protocol 630 obtains storage type specific attributes such as storage type specific controller attributes. In certain embodiments, the storage device protocol 630 communicates with a storage device specific controller 632 to obtain the storage type specific controller attributes 634. In certain embodiments, the storage type specific attributes include storage type specific metadata. In certain embodiments, the storage type specific attributes also include storage type specific network configuration metadata.

In certain embodiments, the processor environment agnostic storage protocol based information handling system firmware management operation 700 provides a unified metadata-based heterogeneous operating system bootloader which functions across a plurality operating systems and storage types.

In certain embodiments, the processor environment agnostic storage protocol based information handling system firmware management operation 700 uses in BT step ‘2’ 738 the seamless transient storage protocol 620 to collect information about initialized storage protocols 644 for a plurality of processor environment vendors, each supplying respective processor environments (PE′A′-PC′n′), a plurality of storage devices, storage devices (Storage Device ‘A’, Storage Device ‘B’-Storage Device ‘n’) such as NVME, or a combination thereof. In certain embodiments, the processor environment agnostic storage protocol based information handling system firmware management operation 700 uses the seamless transient storage protocol 620 in BT step ‘3’ 740 to collect information about native processor environment storage device drivers 642 from a plurality of processor environment vendors, a plurality of storage device vendors, or a combination thereof.

In certain embodiments, the processor environment agnostic storage protocol based information handling system firmware management operation 700 uses the seamless transient storage protocol 620 and collected and acquired metadata 652 in BT step ‘4’ 750 to configure a factory/dynamic table 654. In certain embodiments, the factory/dynamic table 654 is configured using information stored within a platform persistent storage 656. In certain embodiments, the seamless transient storage protocol 620 stores the collected and acquired metadata 652 in the platform persistent storage 656.

Next, when functioning in the BDS phase 450, the processor environment agnostic storage protocol based information handling system firmware management operation 700 uses in BT step ‘5’ 710 the seamless transient storage protocol 620 to detect when boot block corruption in a plurality of storage device modes of operation 712. When corruption is detected, the processor environment agnostic storage protocol based information handling system firmware management operation 700 loads in BT step ‘6’ 781 the remote network factory-configured table 654. In certain embodiments, the processor environment agnostic storage protocol based information handling system firmware management operation 700 initializes in BT step ‘7’ 783 a network stack 732 for communication with a dedicated server. In certain embodiments, the processor environment agnostic storage protocol based information handling system firmware management operation 700 accesses in BT step ‘8’ 785 the network stack 732 to obtain a firmware remediation protocol 736.

Additionally, during the BDS phase 450, when the seamless transient storage protocol 620 detects occurrence of a plurality of boot block corruption 710, the seamless transient storage protocol 620 generates an event 740 to notify a user that a recovery operation has been initiated. In certain embodiments, the processor environment agnostic storage protocol based information handling system firmware management operation 700 configures in BT step ‘9’ 787 the system with the boot block corrupted information 744, In certain embodiments, for added security the boot block information is associated with a hash 746 to encapsulate the boot block corruption information 748. In certain embodiments, the processor environment agnostic storage protocol based information handling system firmware management operation 700 provides in BT step ‘10’ 787 the encapsulated boot block corruption information 748 to the firmware remediation protocol 736.

In certain embodiments, the firmware remediation protocol 736 provides in BT step ‘11’ 791, details of the corrupted boot block 758 to a remote storage location 752. In certain embodiments, the firmware remediation protocol 736 securely sends details of the corrupted boot block 758 to the cloud server for recovery while ensuring security through cryptographic hashing. In certain embodiments, the remote storage location 752 returns recovered boot block details to the information handling system. In certain embodiments, the recovered boot block details are encrypted for security.

In certain embodiments, the firmware remediation protocol 736 verifies in BT step ‘12’ 793, the received recovered boot block details 762. In certain embodiments, the processor environment agnostic storage protocol based information handling system firmware management operation 700 verifies the received recovered boot block details by verifying a cryptographic hash of the received recovered boot block details. In certain embodiment, the received recovered boot block details include AHCI type storage device boot block details, RAID type storage device boot block details, or a combination thereof. In certain embodiments, the firmware remediation protocol 736 updates in BT step ‘13’ 795, boot block information 772 using the received recovered boot block details 762 and notifies a user the update is complete 774.

In certain embodiments, the processor environment agnostic storage protocol based information handling system firmware management operation 700 generates an event 780 to notify a user that a recovery operation has been completed. In certain embodiments, the processor environment agnostic storage protocol based information handling system firmware management operation 700 uses in BT step ‘14’ 797 the boot block information to activate a storage device driver 782 and to use a storage device protocol 630 to communicate with a storage device controller 634.

After the boot block is validated and successfully restored, the respective AHCI/Raid driver is activated. This driver establishes communication with the storage device 636 through the Block IO protocol. In certain embodiments, the processor environment agnostic storage protocol based information handling system firmware management operation 700 in BT step ‘15’ 797 loads the bootloader 680 with the information received from the storage device 636 which in turn is used to seamlessly load the operating system 674 without causing any disruptions to the system.

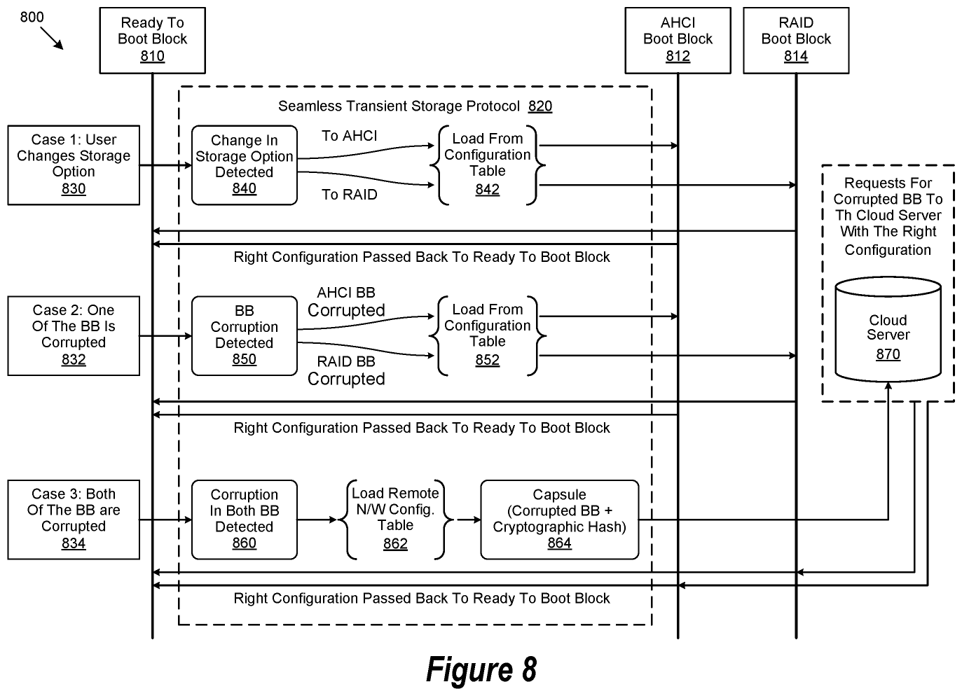

Referring to FIG. 8, a simplified block diagram of a sequence of the performance of a processor environment agnostic storage protocol based information handling system firmware management operation 800 is shown. More specifically, the processor environment agnostic storage protocol based information handling system firmware management operation 800 uses a plurality of types of storage device boot blocks. In various embodiments, the plurality of storage device boot blocks include a ready boot block 810, an AHCI type storage device boot block 812, a RAID type storage device boot block 814, or a combination thereof. In certain embodiments, the ready boot block 810 communicates with the AHCI type storage device boot block 812, the RAID type storage device boot block 814, or a combination thereof, via a seamless transient storage protocol 820.

In various embodiments, the simplified block diagram of a sequence of the performance of a processor environment agnostic storage protocol based information handling system firmware management operation 800 functions in a plurality of use cases. In certain embodiments, the plurality of use cases include a user changes storage option use case 830, a single storage device boot block is corrupted use case 832, a plurality of storage device boot blocks are corrupted use case 834, or a combination thereof.

When functioning in a user changes storage option use case 830, the seamless transient storage protocol 820 detects a change in storage option event at step 840. The seamless transient storage protocol 820 then determines a type of storage device which is being selected for change. If the changes is to an AHCI type storage device, the seamless transient storage protocol loads AHCI type storage information to the AHCI type storage device boot block 812 from a storage information configuration table 842. The AHCI type storage device boot block 812 then communicates with the ready boot block 810 to indicate the information AHCI storage information has been successfully loaded. If the change is to a RAID type storage device, the seamless transient storage protocol loads RAID type storage information to the RAID type storage device boot block 814 from a storage information configuration table 842. The RAID type storage device boot block 814 then communicates with the ready boot block 810 to indicate the information RAID storage information has been successfully loaded.

When functioning in a single storage device boot block is corrupted use case 832, the seamless transient storage protocol 820 detects a corrupted boot block at step 850. The seamless transient storage protocol 820 then determines a type of storage device which is associated with the corrupted boot block. If the corrupted boot block is associated with an AHCI type storage device, the seamless transient storage protocol loads AHCI type storage information to the AHCI type storage device boot block 812 from a storage information configuration table 852. The AHCI type storage device boot block 812 then communicates with the ready boot block 810 to indicate the information AHCI storage information has been successfully loaded. If the corrupted boot block is associated with a RAID type storage device, the seamless transient storage protocol loads RAID type storage information to the RAID type storage device boot block 814 from a storage information configuration table 852. The RAID type storage device boot block 814 then communicates with the ready boot block 810 to indicate the information RAID storage information has been successfully loaded.

When functioning in plurality of storage device boot blocks are corrupted use case 834, the seamless transient storage protocol 820 detects a plurality of corrupted boot blocks at step 860. The seamless transient storage protocol 820 then loads network configuration information. In certain embodiments, the network configuration information is located from a network configuration table 862. In certain embodiments, the network configuration table 862 is retrieved from a remote storage location. The seamless transient storage protocol 820 then generates an encapsulated boot block capsule 864. In certain, the encapsulated boot block capsule 864 includes information regarding the corrupted boot blocks as well as security information. In certain embodiments, the security information includes a cryptographic hash. The seamless transient storage protocol 820 then provides the encapsulated boot block capsule to a remote storage location 870. The remote storage location 870 then uses the encapsulated boot block capsule to access uncorrupted storage device boot block information. The remote storage location 870 then provides the uncorrupted storage device boot block information to respective boot blocks. In certain embodiments, the respective boot blocks include the AHCI boot block 812, the RAID boot block 814, or a combination thereof.

The seamless transient storage protocol loads AHCI type storage information to the AHCI type storage device boot block 812 from the remote storage location. The AHCI type storage device boot block 812 then communicates with the ready boot block 810 to indicate the information AHCI storage information has been successfully loaded and to provide the uncorrupted AHCI boot block information. The seamless transient storage protocol loads RAID type storage information to the RAID type storage device boot block 814 from the remote storage location. The RAID type storage device boot block 814 then communicates with the ready boot block 810 to indicate the information RAID storage information has been successfully loaded and to provide the uncorrupted RAID boot block information.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed BIOS, the distributed BIOS including a BIOS component and a BIOS variable;
identifying a processor environment installed on an information handling system from a plurality of processor environments;
performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

2. The method of claim 1, wherein:
the processor environment agnostic storage protocol based information handling system firmware management operation includes a processor environment agnostic seamless transient storage protocol.

3. The method of claim 1, wherein:
the processor environment agnostic storage protocol based information handling system firmware management operation includes a processor environment agnostic boot loader, the processor environment agnostic boot loader enabling unified booting of the information handling system across the plurality of storage configurations.

4. The method of claim 1, wherein:
the plurality of storage configurations include an advanced host controller interface (AHCI) type storage configuration and a redundant array of independent disks (RAID) storage configuration.

5. The method of claim 1, wherein:
each of the plurality of storage configurations include a respective boot block; and,
the recovery from the issue relating to one of the plurality of storage configurations include obtaining an uncorrupted boot block associated with the one of the plurality of storage configurations.

6. The method of claim 5, wherein:
the uncorrupted boot block is retrieved from a remote storage location.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS, the distributed BIOS including a BIOS component and a BIOS variable;
identifying a processor environment installed on an information handling system from a plurality of processor environments;
performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

8. The system of claim 7, wherein:
the processor environment agnostic storage protocol based information handling system firmware management operation includes a processor environment agnostic seamless transient storage protocol.

9. The system of claim 7, wherein:
the processor environment agnostic storage protocol based information handling system firmware management operation includes a processor environment agnostic boot loader, the processor environment agnostic boot loader enabling unified booting of the information handling system across the plurality of storage configurations.

10. The system of claim 7, wherein:
the plurality of storage configurations include an advanced host controller interface (AHCI) type storage configuration and a redundant array of independent disks (RAID) storage configuration.

11. The system of claim 7, wherein:
each of the plurality of storage configurations include a respective boot block; and,
the recovery from the issue relating to one of the plurality of storage configurations include obtaining an uncorrupted boot block associated with the one of the plurality of storage configurations.

12. The system of claim 11, wherein:
the uncorrupted boot block is retrieved from a remote storage location.

13. A non-transitory, computer-readable storage medium embodying computer program code, the computer program code comprising computer executable instructions configured for:
providing an information handling system with a distributed BIOS, the distributed BIOS including a BIOS component and a BIOS variable;
identifying a processor environment installed on an information handling system from a plurality of processor environments;
performing a processor environment agnostic storage protocol based information handling system firmware management operation, the processor environment agnostic storage protocol based information handling system firmware management operation enabling storage device recovery from an issue relating to one of a plurality of storage configurations during a pre-boot phase of operation.

14. The non-transitory, computer-readable storage medium of claim 13, wherein:
the processor environment agnostic storage protocol based information handling system firmware management operation includes a processor environment agnostic seamless transient storage protocol.

15. The non-transitory, computer-readable storage medium of claim 13, wherein:
the processor environment agnostic storage protocol based information handling system firmware management operation includes a processor environment agnostic boot loader, the processor environment agnostic boot loader enabling unified booting of the information handling system across the plurality of storage configurations.

16. The non-transitory, computer-readable storage medium of claim 13, wherein:
the plurality of storage configurations include an advanced host controller interface (AHCI) type storage configuration and a redundant array of independent disks (RAID) storage configuration.

17. The non-transitory, computer-readable storage medium of claim 13, wherein:
each of the plurality of storage configurations include a respective boot block; and,
the recovery from the issue relating to one of the plurality of storage configurations include obtaining an uncorrupted boot block associated with the one of the plurality of storage configurations.

18. The non-transitory, computer-readable storage medium of claim 17, wherein:
the uncorrupted boot block is retrieved from a remote storage location.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
